(19) United States
(12) Patent Application Publication
(10) Pub. No.: US 2026/0326506 A1
(43) Pub. Date: Oct. 22, 2026

(54) HEAT EXCHANGER ASSEMBLY FOR A VEHICLE

(71) Applicant: Ford Global Technologies, LLC, Dearborn, MI (US)

(72) Inventors: Jill Catherine Huptas, Köln (DE); Scott Thomas Vehige, Woodhaven, MI (US)

(73) Assignee: Ford Global Technologies, LLC, Dearborn, MI (US)

(21) Appl. No.: 19/529,502

(22) Filed: Feb. 4, 2026

(30) Foreign Application Priority Data
Mar. 12, 2025 (DE) 102025109471.3

(51) Int. Cl. B60H 1/06; B60H 1/22; B60H 1/32

(52) U.S. Cl. CPC B60H 1/06; B60H 1/2226; B60H 1/321

(57) ABSTRACT

A heat exchanger assembly for a vehicle comprising a surroundings heat exchanger configured to receive a working fluid and to exchange heat with an air flow. In order to enable a heat exchanger of an electric vehicle to be operated energy-efficiently and as far as possible without interruption, the heat exchanger assembly has at least one heating module which is electrically operable and is configured to, independently of the working fluid, transfer heat to and thus heat the surroundings heat exchanger.

### CROSS-REFERENCE TO RELATED APPLICATION

This application claims foreign priority benefits under 35 U.S.C. § 119(a)-(d) to German Application No. 102025109471.3 filed Mar. 12, 2025, which is hereby incorporated by reference in its entirety.

### FIELD OF THE DISCLOSURE

The present disclosure generally relates to a heat exchanger assembly for a vehicle, and more specifically relates to a surroundings heat exchanger that is configured to receive a working fluid and to exchange heat with an air flow.

### BACKGROUND OF THE DISCLOSURE

Motor vehicles having an internal combustion engine may utilize the waste heat of the engine to heat the vehicle interior compartment, however, this is not possible in the same way in electric vehicles, including battery-powered electric vehicles and fuel cell vehicles. Heating the interior compartment of an electric vehicle with an electrical PTC heater is generally inefficient, and, therefore, a heat pump system is often used in order to generate heat more efficiently. In general, in this case, a considerable proportion of the heat required for heating purposes is extracted from the surroundings of the vehicle. However, efficiency decreases significantly in cold ambient conditions, for example below -10° C. The possibility of icing of the surroundings-side heat exchanger also increases. To prevent or eliminate such icing, it is possible to temporarily heat the surroundings-side heat exchanger, wherein the heat may be taken from heat sources within the vehicle.

It would be desirable to provide for enhanced energy-efficient operation of a heat exchanger for a vehicle.

### SUMMARY OF THE DISCLOSURE

According to a first aspect of the present disclosure, a heat exchanger assembly for a vehicle has a surroundings heat exchanger that is configured to receive a working fluid and to exchange heat with an air flow and at least one heating module which is electrically operable and is configured to, independently of the working fluid, transfer heat to and thus heat the surroundings heat exchanger.

Embodiments of the first aspect of the present disclosure can include any one or a combination of the following features:
the at least one heating module is heat-conductingly connected to the surroundings heat exchanger and is configured to transfer heat to the surroundings heat exchanger by heat conduction;
the at least one heating module is configured to heat the air flow and thereby transfer heat to the surroundings heat exchanger;
the at least one heating module is configured to transfer heat to the surroundings heat exchanger by infrared radiation;
the at least one heating module is arranged on the surroundings heat exchanger;
an adjustable shut-off unit manipulates the air flow;
the at least one heating module is arranged on the shut-off unit;
a radiator grille is arranged in front of the surroundings heat exchanger with respect to the air flow;
the at least one heating module is arranged on the radiator grille;
a fan unit is configured to at least partially generate the air flow;
the at least one heating module is arranged on the fan unit;
the at least one heating module has an electrically heatable heating element having a heating resistor;
the at least one heating module has a heat-conducting element which is heat-conductingly connected to a heating element and is configured to dissipate heat from the heating element;
a control unit is configured to activate the at least one heating module in a deicing mode and to deactivate the at least one heating module in a normal mode;and
at least one sensor determines a temperature of the surroundings heat exchanger, wherein the control unit is configured to switch between the deicing mode and the normal mode depending on the temperature.

According to a second aspect of the present disclosure, a heat exchanger assembly for a vehicle has a surroundings heat exchanger that is configured to receive a working fluid and to exchange heat with an air flow and at least one heating module which is electrically operable and is configured to, independently of the working fluid, transfer heat to and thus heat the surroundings heat exchanger. A control unit is configured to activate the at least one heating module in a deicing mode and to deactivate the at least one heating module in a normal mode. At least one sensor determines a temperature of the surroundings heat exchanger. The control unit is configured to switch between the deicing mode and the normal mode depending on the temperature.

Embodiments of the second aspect of the present disclosure can include any one or a combination of the following features:
the at least one heating module is heat-conductingly connected to the surroundings heat exchanger and is configured to transfer heat to the surroundings heat exchanger by heat conduction;
the at least one heating module is configured to heat the air flow and thereby transfer heat to the surroundings heat exchanger;
the at least one heating module is arranged on the surroundings heat exchanger;
an adjustable shut-off unit manipulates the air flow;
the at least one heating module is arranged on the shut-off unit;
a radiator grille is arranged in front of the surroundings heat exchanger with respect to the air flow;
the at least one heating module is arranged on the radiator grille;
a fan unit is configured to at least partially generate the air flow; and
the at least one heating module is arranged on the fan unit.

According to a third aspect of the present disclosure, a vehicle has a heat exchanger assembly. The heat exchanger assembly has a surroundings heat exchanger that is configured to receive a working fluid and to exchange heat with an air flow and at least one heating module which is electrically operable and is configured to, independently of the working fluid, transfer heat to and thus heat the surroundings heat exchanger.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic illustration of an electric vehicle having a first embodiment of a heat exchanger assembly according to the disclosure;

FIG. 2 is a diagrammatic illustration of a heat transport system having a part of the heat exchanger assembly from FIG. 1;

FIG. 3 is a perspective illustration of a radiator grille of the first embodiment of the heat exchanger assembly from FIG. 1;

FIG. 4 is a perspective illustration of a radiator grille of a second embodiment of a heat exchanger assembly;

FIG. 5 is a perspective illustration of a radiator grille of a third embodiment of a heat exchanger assembly;

FIG. 6 is a perspective illustration of a radiator grille of a fourth embodiment of a heat exchanger assembly;

FIG. 7 is a perspective illustration of a surroundings heat exchanger unit of a fifth embodiment of a heat exchanger assembly;

FIG. 8 is an enlarged detail view from FIG. 7 showing a portion of the surrounding heat exchanger unit;

FIG. 9 is a perspective illustration of a shut-off unit of a sixth embodiment of a heat exchanger assembly; and

FIG. 10 is a perspective illustration of a fan unit of a seventh embodiment of a heat exchanger assembly.

### DETAILED DESCRIPTION OF PREFERRED EMBODIMENTS

In the various figures, identical parts are always denoted by the same reference signs, for which reason said parts will generally also be described only once. The expressions "first", "second" etc. used in this application serve merely for the purposes of distinction. In particular, the use thereof is not intended to imply a sequence or priority of the objects mentioned in conjunction with these expressions.

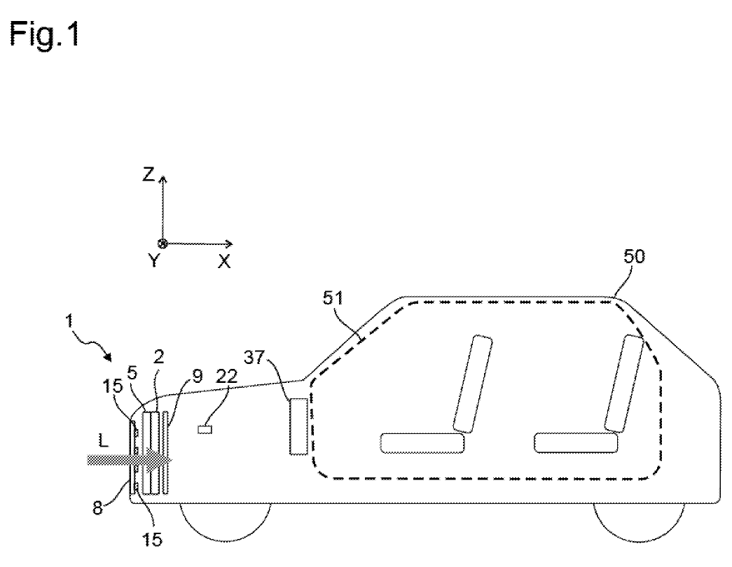

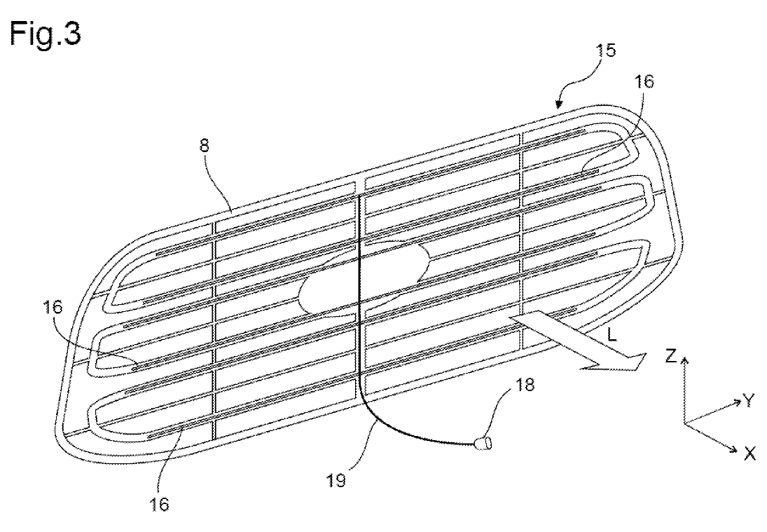

FIG. 1 shows a vehicle 50, in this example a battery-powered electric vehicle (BEV), having a heat exchanger assembly 1 according to the disclosure. A longitudinal axis X, a transverse axis Y and a vertical axis Z of the vehicle 50 are plotted here, and in the figures that follow. The illustration schematically shows a vehicle interior compartment 51, which can also be referred to as a passenger cell. A surroundings heat exchanger 2 is arranged in the front region of the vehicle 50. The surroundings heat exchanger is provided for extracting heat from an air flow L, which heat is to be supplied via a heat transport system 40 to a heating heat exchanger 37. The vehicle interior compartment 51 can be heated with the heating heat exchanger 37. The vehicle interior compartment 51 represents one example of a vehicle region, and heating of other vehicle regions may alternatively also be provided. A fan unit 9 is arranged behind the surroundings heat exchanger 2 with respect to the longitudinal axis X. The fan unit 9 is electrically operable and can at least partially generate the air flow L if a traveling movement of the vehicle 50 is not sufficient for this purpose. A shut-off unit 5 is arranged in front of the surroundings heat exchanger 2 with respect to the longitudinal axis X. Arranged in front of the shut-off unit 5 in turn, there is a radiator grille 8 which constitutes a forward termination of the vehicle body of the vehicle 50. The radiator grille 8 illustrated in different embodiments in FIG. 3 to 6 is of apertured design such that the air flow L can pass through the radiator grille 8. FIG. 1 schematically illustrates a heating module 15 which is arranged on the radiator grille 8 and which can be controlled by a control unit 22.

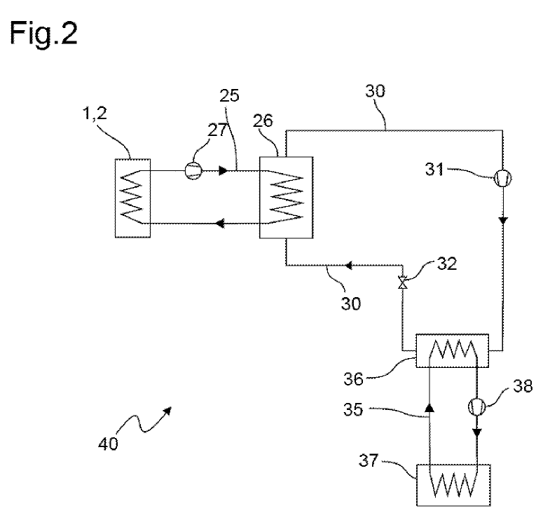

FIG. 2 is a diagrammatic illustration of the heat transport system 40, wherein the arrangement of the individual components may self-evidently differ from their actual spatial arrangement. The surroundings heat exchanger 2 is fluidically connected via a primary circuit 25 to a primary heat exchanger 26. A frost-protected aqueous mixture, for example a water-glycol mixture, can circulate in the primary circuit 25. A primary pump unit 27 serves to maintain a circulation within the primary circuit 25. The primary heat exchanger 26 is incorporated in an intermediate circuit 30, within which it forms an evaporator, while a secondary heat exchanger 36 forms a liquefier or condenser. A working fluid is conveyed from the primary heat exchanger 26 to the secondary heat exchanger 36 by using a compressor 31, and in the process the working fluid is liquefied in the region of the secondary heat exchanger 36. An expansion valve 32 arranged downstream of the secondary heat exchanger 36 has the effect that the working fluid expands, and in particular can change into a gaseous state, in the region of the primary heat exchanger 26. The working fluid thus absorbs heat at the primary heat exchanger 26, the heat being extracted from the primary circuit 25. The secondary heat exchanger 36 is incorporated in a secondary circuit 35. The secondary circuit conducts a fluid of an identical composition to that in the primary circuit 25. A secondary pump unit 38 conveys the fluid. Heat is supplied to the secondary circuit 35 via the secondary heat exchanger 36. The secondary circuit 35 has the aforementioned heating heat exchanger 37, by which the heat absorbed from the secondary circuit 35 can be at least partially released to the vehicle interior compartment 51. The heat transport system 40 shown here is to be understood as an example, and may be modified in a variety of ways. For example, the primary circuit 25 could be omitted, with the primary heat exchanger 26 being able, as a surroundings heat exchanger 2, to exchange heat directly with the surroundings. It would also be possible for the secondary circuit 35 to be omitted, with the secondary heat exchanger 36 being able, as a heating heat exchanger 37, to release heat directly to the vehicle interior compartment 51.

The function of the heat transport system 40 is dependent inter alia on the surroundings heat exchanger 2 and the fluid F conducted therein being at a lower temperature than the air flow L. It would otherwise not be possible for heat to be extracted from the air flow L. However, in particular in the presence of low ambient temperatures, this can result in icing of the surroundings heat exchanger 2, which greatly impairs its function. This is counteracted by use of the heating module 15.

FIG. 3 is a perspective illustration of the radiator grille 8 according to a first embodiment of a heat exchanger assembly 1 according to the disclosure. The figure shows the rear face, with respect to the longitudinal axis X, of the radiator grille 8, the face thus facing toward the surroundings heat exchanger 2 and not being visible from the outside. In this case, the heating module 15 has a plurality of heating elements 16 in the form of heating wires. Owing to their thin linear form, the heating elements 16 can be easily concealed behind the grid-like structure of the radiator grille 8. The heating elements are connected via a connecting cable 19 to a socket 18, which can be connected to a low-voltage supply (not illustrated) of the vehicle 50. The low voltage may in particular be 12 V. When a voltage is applied, a current flows through the heating wires and results in heating of the heating elements 16 and thus also of the passing air flow L. Said air flow is subsequently incident on the surroundings heat exchanger 2, contributing to the deicing thereof.

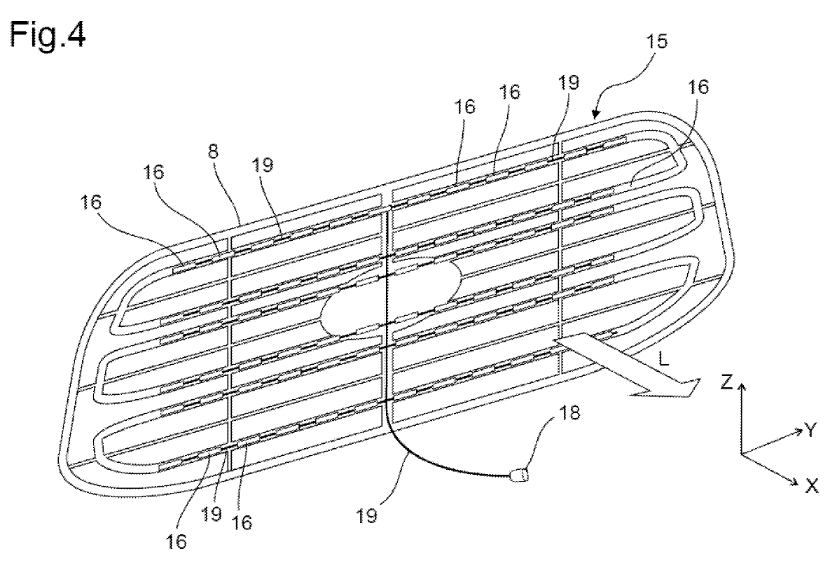

FIG. 4 is a perspective illustration of the radiator grille 8 according to a second embodiment of a heat exchanger assembly 1 according to the disclosure. In this case, the heating module 15 has a plurality of heating elements 16, which are designed as PTC heating elements and are connected by connecting cables 19 to form a network. As in the first embodiment, the heating elements 16 can be connected via a connecting cable 19 and an associated socket 18 to a low-voltage supply of the vehicle 50.

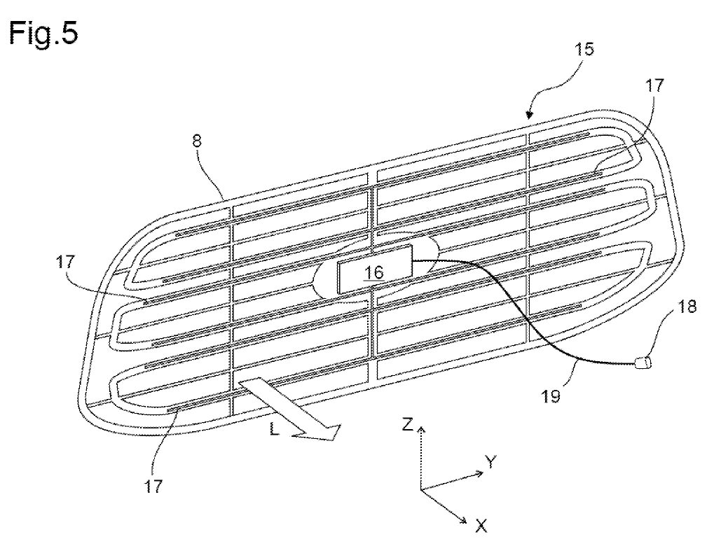

FIG. 5 shows a radiator grille 8 having a heating module 15 according to a third embodiment. A single centrally arranged heating element 16 is in turn connected via a connecting cable 19 to a socket 18. The heating element 16 may have one or more suitable heating resistors. A plurality of branching, linear heat-conducting elements 17, which may include, for example, copper or some other good heat conductor, are in thermal contact with the heating element 16. When the heating element 16 is heated, the heat-conducting elements 17 dissipate heat and distribute same over a relatively large region of the radiator grille 8. This, too, causes heating of the air flow L. In each of the embodiments according to FIG. 3, 4 and 5, a shut-off unit 5 may be interposed between the radiator grille 8 and the surroundings heat exchanger 2. The shut-off unit may additionally be equipped with a heating module 15 in order to ensure effective heat transfer to the surroundings heat exchanger 2 even when the shut-off unit 5 is fully or partially closed.

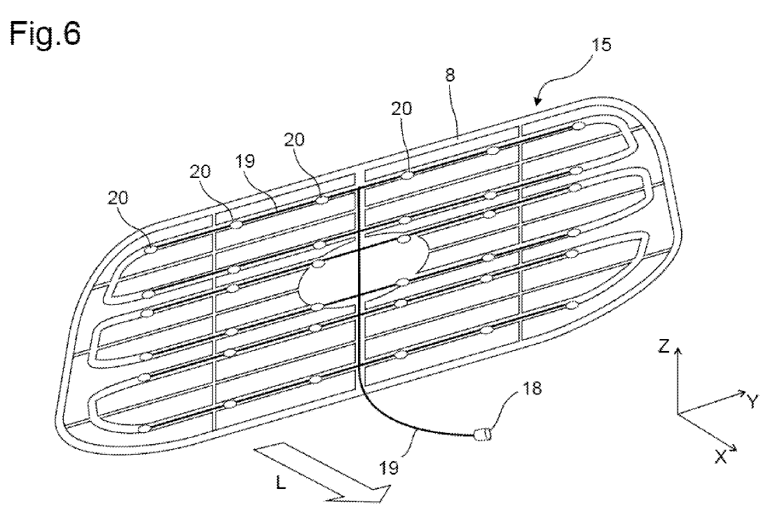

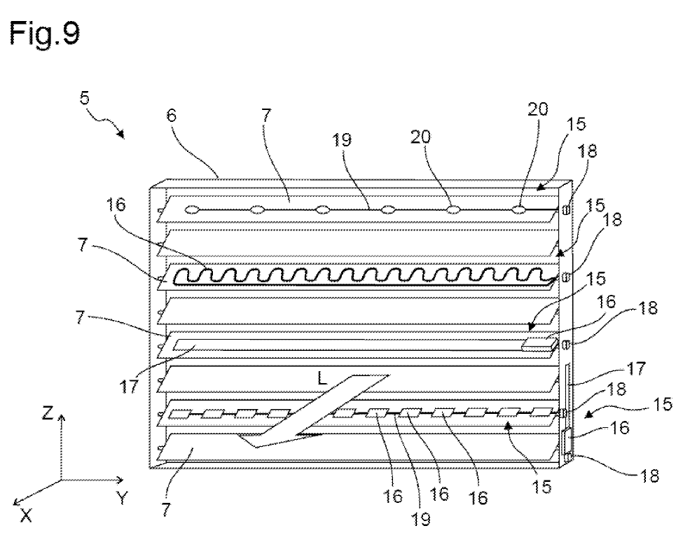

FIG. 6 shows a radiator grille 8 having a heating module 15 according to a fourth embodiment. In this case, a plurality of infrared diodes 20 is arranged on the rear face of the radiator grille 8. The infrared diodes 20 are in turn connected by the connecting cables 19 to a socket 18. The infrared diodes 20 emit infrared radiation, which can be partially absorbed by the radiator grille 8 and in particular by further components of the heat exchanger assembly 2. By being arranged on the rear face of the radiator grille 8, the infrared diodes 20 irradiate in particular the shut-off unit 5 and, under some circumstances, also the surroundings heat exchanger 2 situated therebehind. Heating of the shut-off unit 5 leads in turn to heating of the air flow L, which in turn heats the surroundings heat exchanger 2. In order to allow direct irradiation of the surroundings heat exchanger 2 even when the shut-off unit 5 is fully or partially closed, it is expedient for infrared diodes 20 to additionally or alternatively be provided on the shut-off unit 5, as will be described below with reference to FIG. 9.

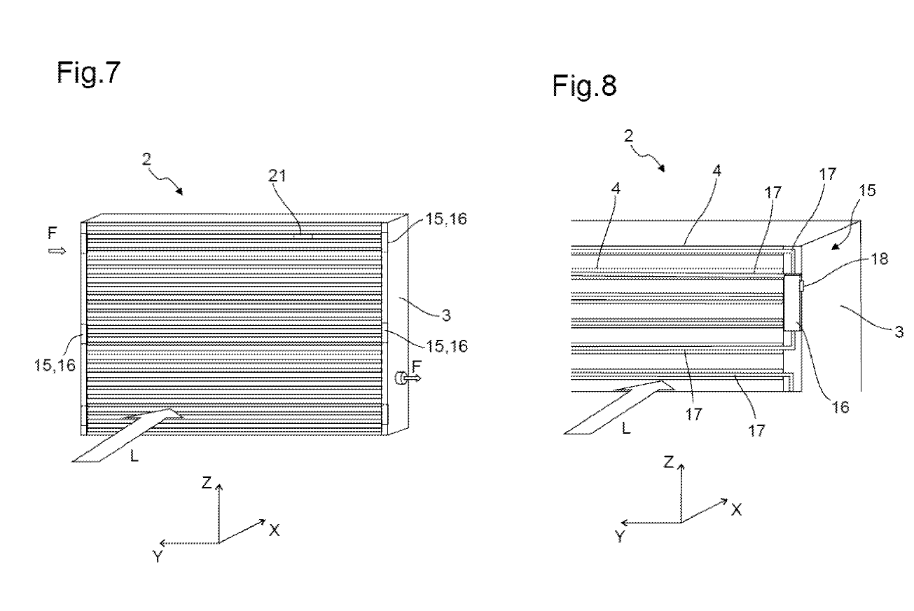

FIGS. 7 and 8 show a surroundings heat exchanger 2 according to a fifth embodiment of a heat exchanger assembly 1 according to the disclosure. The surroundings heat exchanger 2 is illustrated here in simplified form. The surroundings heat exchanger has a container 3 on each of the two sides with respect to the transverse axis Y, which containers can also be referred to as end tanks and via which containers the working fluid F is received and discharged again. The two containers 3 are connected by a plurality of tubes 4 which extend parallel to the transverse axis Y and which are mutually spaced in order to allow the air flow L to pass through. In the embodiment shown here, a plurality of heating modules 15, of which there are six in total, is arranged on the containers 3. As can be seen in the detail view of FIG. 8, each heating module 15 has a heating element 16, which in turn may have one or more heating resistors. A socket 18 for connection to a low-voltage supply is arranged on the heating element 16. A plurality of heat-conducting elements 17 extend away from the heating element 16, which heat-conducting elements also extend along the tubes 4. Since both the heating element 16 and the heat-conducting element 17 are in heat-conducting contact with the surroundings heat exchanger 2, the latter is heated in an effective manner by the operation of the heating modules 15. FIG. 7 also schematically illustrates a sensor 21, which is designed to measure a temperature of the surroundings heat exchanger 2. The sensor has a signal-transmitting connection (not illustrated) to the control unit 22.

FIG. 9 shows a shut-off unit 5 according to a sixth embodiment of a heat exchanger assembly 1 according to the disclosure. The shut-off unit 5 has a frame 6 which delimits the air flow L with respect to the transverse axis Y and with respect to the vertical axis Z. A plurality of slat-like shut-off elements 7 are pivotably connected to the frame 6 and configured to selectively allow or block the air flow L. FIG. 9 shows a perspective view from the rear, that is to say from the side which, in the installed state, faces toward the surroundings heat exchanger 2. In this case, four different heating modules 15 are illustrated. Although five different types of heating modules 15 are illustrated here on one shut-off unit 5, it is also possible for five or more heating modules 15 of the same type to be used instead. A first heating module 15 has a plurality of infrared diodes 20, which are arranged on a shut-off element 7. The infrared diodes are connected via a connecting cable 19 to a socket 18 on the frame 6. A second heating module 15 has a heating element 16 which is attached as a heating wire, laid in part in meandering fashion, to a shut-off element 7. In the case of a third heating module 15, a heating element 16 is arranged at one end of a shut-off element 7, with a strip-like heat-conducting element 17 extending from the heating element 16 over almost the entire length of the shut-off element 7. A fourth heating module 15 also has a combination of a heating element 16 and a heat-conducting element 17, which are however fastened to the frame 6 laterally with respect to the transverse axis Y. A fifth heating module 15 has a plurality of heating elements 16, which are designed as PTC heating elements and are connected via a connecting cable 19 to a socket 18. The attachment of infrared diodes or a heating wire to the lateral frame 6 of the shut-off element 7 is also conceivable. In principle, additional heating elements on the frame 6 of the shut-off unit 5 assist the heating of the air flow even when the shut-off unit 5 is open, if no heating elements are provided on the radiator grille. While the first heating module 15 is suitable in particular for heating the surroundings heat exchanger 2 by infrared radiation, the second, third, fourth and fifth heating module 15 are suitable in particular for heating the air flow L and thereby transferring heat to the surroundings heat exchanger 2.

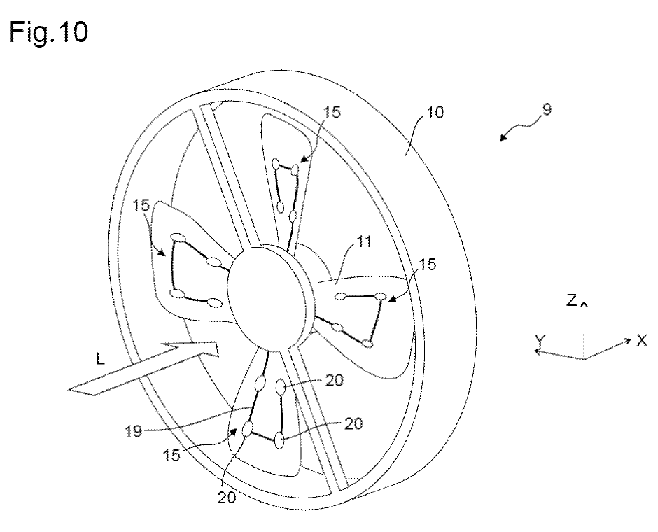

FIG. 10 shows a fan unit 9 according to a seventh embodiment of a heat exchanger assembly 1 according to the disclosure. The fan unit 9 has a static fan frame 10 and has a fan propeller 11 that is rotatable relative to said fan frame. A total of four heating modules 15 are arranged on the fan propeller 11, which heating modules in this case each have a plurality of infrared diodes 20 which are connected by connecting cables 19. The connecting cables 19 may in turn be connected via sliding contacts to a socket (not illustrated here) which is arranged on the fan frame 10 and which in turn serves for connection to a low-voltage supply. The infrared diodes 20 are arranged on the front face of the fan propeller 11 with respect to the longitudinal axis X and thus face toward the surroundings heat exchanger 2. When activated, the infrared diodes thus irradiate said surroundings heat exchanger with infrared radiation from the rear, thus heating the surroundings heat exchanger.

The embodiments shown here are merely examples. In particular, it is also possible for two or more of the embodiments shown to be combined with one another. In each case, the operation of the at least one heating module 15 is controlled by the control unit 22. The control unit may activate a heating module 15 in a deicing mode and deactivate same in a normal mode, wherein the switch may be made between the deicing mode and surroundings heat exchanger 2. The control unit 22 may for example switch into the deicing mode if the temperature falls below a first threshold temperature and is also below the ambient temperature. The control unit 22 may switch into the normal mode if the temperature is higher than a second threshold temperature, which may be a few degrees higher than the first threshold temperature. The switch into the normal mode may additionally take place only if the temperature is higher, by a defined difference, than the ambient temperature.

The features and measures individually specified in the following description may be combined with one another in any technically meaningful way and reveal further refinements of the disclosure. The description additionally characterizes and specifies the disclosure, in particular in conjunction with the figures.

The disclosure provides a heat exchanger assembly for a vehicle. The heat exchanger assembly is normally provided for a road vehicle, in particular a motor vehicle such as a bus, truck or passenger car. Use for rail vehicles or watercraft would however also be conceivable, as would use for a vehicle without its own drive, for example a trailer. The heat exchanger assembly may advantageously be provided for an electric vehicle. The term "electric vehicle" refers here to a vehicle comprising at least one electric motor that serves for the propulsion of the vehicle. In particular, it may be a purely electrically operated vehicle, but use of the disclosure in hybrid vehicles is not precluded. The heat exchanger assembly may serve at least intermittently for controlling the temperature of regions or components of the vehicle. In this context, "temperature control" refers to the targeted manipulation of a temperature, in particular in order to keep said temperature within an intended range, or bring said temperature into such a range. In particular, the heat exchanger assembly may be comprised by a heat transport system which serves for manipulating the temperature, in particular controlling the temperature, of a vehicle region. The heat transport system may be provided for manipulating the temperature of a vehicle interior compartment, and in this case may also be referred to as a climate control system.

The heat exchanger assembly comprises a surroundings heat exchanger that is configured to receive a working fluid and to exchange heat with an air flow. The surroundings heat exchanger can receive a working fluid, which may take the form of a large number of refrigerants in gaseous or liquid form or any type of liquid coolant. Accordingly, the surroundings heat exchanger has at least one interior space for receiving the working fluid. It may also have at least one inlet and one outlet through which the working fluid can flow in and out. The surroundings heat exchanger is also configured to exchange heat with an air flow. It may be possible for the air flow to be fully or partially generated by a traveling movement of the vehicle. A fan unit drivable or driven by a motor is advantageously provided, the fan unit being configured to fully or partially generate the air flow. The fan unit can be regarded as part of the heat exchanger assembly. The air flow is incident on the surroundings heat exchanger, whereby heat can be exchanged between the air flow and the working fluid that is conducted in the surroundings heat exchanger. In a manner that is known in principle, the surroundings heat exchanger may have an apertured, in particular grid-like structure, such that the air flow can pass through the grid-like structure. The term “surroundings heat exchanger” is not to be interpreted as limiting. The term however indicates that the air flow is preferably ambient air that originates from the surroundings of the vehicle. In particular, the surroundings heat exchanger may be installed at the front of the vehicle with respect to a vehicle longitudinal axis, in order to achieve an optimum incident flow. Other installation positions are however also conceivable.

Within the aforementioned heat transport system, the surroundings heat exchanger may be fluidically connected via a primary circuit to a primary heat exchanger. Here and below, “fluidically connected” means that the connection is such that fluid can be conducted from one component to the other. It can also be stated that fluidically connected components have a fluidic connection or have a fluid-conducting connection. The primary heat exchanger may be fluidically connected by an intermediate circuit to a secondary heat exchanger. The intermediate circuit absorbs heat from the primary circuit, with the heat transfer taking place via the primary heat exchanger. The intermediate circuit then releases heat via the secondary heat exchanger. The intermediate circuit is advantageously designed as a heat pump circuit and has a compressor and an expansion valve. The intermediate circuit thus functions in accordance with the principle of a heat pump. Here, heat is conveyed from the primary heat exchanger to the secondary heat exchanger, with the conveyance of heat being driven by the compressor. The secondary heat exchanger may be fluidically connected via a secondary circuit to a heating heat exchanger that is assigned to the vehicle region. That is to say, the heating heat exchanger is configured to transfer heat to the vehicle region. The heating heat exchanger may be arranged in the vehicle region or directly adjacent to the vehicle region. The heating heat exchanger may be assigned a fan by which heated air is blown into the vehicle region. The secondary circuit can absorb heat from the intermediate circuit via the secondary heat exchanger. The embodiment of a heat transport system described here represents just one possible application of the heat exchanger assembly according to the disclosure, and other applications are expressly also conceivable.

According to the disclosure, the heat exchanger assembly has at least one heating module which is electrically operable and is configured to, independently of the working fluid, transfer heat to and thus heat the surroundings heat exchanger. The heating module is electrically operable, that is to say has electrical connections, such that an electrical voltage can be applied and an electrical current can flow through the heating module. If the heating module is activated, the heating module heats the surroundings heat exchanger. In this context, “heating” refers in particular to an increase of the temperature of the surroundings heat exchanger, and more generally refers to any form of heat supply to the surroundings heat exchanger, even if this is at least intermittently compensated for by some other dissipation of heat. The action of the heating module can prevent or reverse icing of the surroundings heat exchanger. Here, the heating module heats the surroundings heat exchanger not internally via the working fluid but independently of the working fluid. In particular, the heating module may heat the heat exchanger externally. Since the action is independent of the working fluid, the surroundings heat exchanger can continue to be operated normally throughout, and thus for example assist the manipulation or control of the temperature of a vehicle interior compartment. It has also been found that a heating module according to the disclosure makes it possible to save energy in relation to deicing via the working fluid. The heating module may be advantageously operable with a low voltage of at most 30 V, and more particularly about 12 V, for example. This is in contrast to high voltage heating units which are used for example for heating a working fluid and often require a high voltage of 60 V or higher.

There are various possibilities for the transfer of heat to the surroundings heat exchanger. In one embodiment, at least one heating module is heat-conductingly connected to the surroundings heat exchanger and is configured to transfer heat to the surroundings heat exchanger by heat conduction. The heating module may be connected to the surroundings heat exchanger directly or indirectly, for example via an interposed element with sufficient heat conductivity. The heating module may in particular be fastened to the surroundings heat exchanger. The heating module is advantageously arranged on an outer face, which is averted from the aforementioned interior space, of the surroundings heat exchanger. It would however also be conceivable for the heating module to be fully or partially integrated into a wall of the surroundings heat exchanger. In this embodiment, the transfer of heat from the heating module is based on heat conduction, but this does not need to be the only underlying transfer mechanism.

A further possibility includes at least one heating module being configured to heat the air flow, and transfer heat to the surroundings heat exchanger in this way. In this embodiment, the heat transfer is based on convection. The heating module is heated to a temperature higher than that of the air flow. It is thus primarily the air flow which is heated, the air flow subsequently being incident on the surroundings heat exchanger. Heat is subsequently transferred from the air flow to the surroundings heat exchanger. Overall, the air flow is utilized as a transfer medium. In this embodiment, there is no need for a heat-conducting connection between the heating module and the surroundings heat exchanger. This is however not ruled out, that is to say this embodiment may be combined with that mentioned above.

In one embodiment, at least one heating module is configured to transfer heat to the surroundings heat exchanger by infrared radiation. The heating module emits infrared radiation. This may in particular be electromagnetic radiation having at least a wavelength between 780 nm and 1000 nm. The heating module may be configured as a radiant heater or radiator, with a continuous spectrum of electromagnetic radiation being emitted, which also contains wavelengths outside the infrared range. This may advantageously be combined with heat transfer by heat conduction. In the operating state, heating module is at a temperature higher than that of the surroundings heat exchanger. The heating module may have at least one infrared light source. An infrared light source may also be designed as an infrared LED. This would have the advantage over a radiant heater that the heating module itself does not need to exhibit a significantly elevated temperature in order to generate significant amounts of infrared radiation. The heating module may be configured to directly irradiate the surroundings heat exchanger. It would however also be conceivable for the heat exchanger assembly to have a reflector which reflects infrared radiation from the heating module in the direction of the surroundings heat exchanger. It would also be conceivable for a further element to be irradiated, which in turn is heat-conductingly connected to the surroundings heat exchanger.

There are various possibilities with regard to the arrangement of the heating module. In one embodiment, at least one heating module is arranged on the surroundings heat exchanger. The heating module may in particular be fastened to the surroundings heat exchanger. This also includes the possibility of the heating module being fully or partially integrated into the surroundings heat exchanger, for example into a wall that delimits the aforementioned interior space. An arrangement on the surroundings heat exchanger is suitable in particular for heat transfer by heat conduction, because the heating module can be heat-conductingly connected to the surroundings heat exchanger. It would however also be possible, for example, for an infrared light source to be fastened to the surroundings heat exchanger and configured to irradiate same.

The heat exchanger assembly may have an adjustable shut-off unit with which the air flow can be manipulated, wherein at least one heating module is arranged on the shut-off unit. The shut-off unit serves for manipulating the air flow and may in particular be configured to shut off the air flow at least partially or in certain regions. It may also be referred to as a radiator grille closure unit or shutter unit. The shut-off unit is preferably adjustable by a motor. It may be arranged in front of the surroundings heat exchanger with respect to the vehicle longitudinal axis. The shut-off unit may have a plurality of shut-off elements, which may for example be connected movably to a frame of the air passage assembly. In particular, each shut-off element may be pivotable. The shut-off elements may for example be designed as flaps or slats. At least in some embodiments, each shut-off element may also be referred to as a radiator grille closure flap. The shut-off elements may be arranged on a frame of the shut-off unit. A heating module may be arranged at least partially on the frame, though an arrangement at least partially on a shut-off element is also conceivable. In this embodiment, provision may advantageously be made for the heat transfer to take place via the air flow, by virtue of the heating module heating the air flow, which is subsequently incident on the surroundings heat exchanger. It would however also be possible, for example, for a heating module arranged on the shut-off unit to heat the surroundings heat exchanger by infrared radiation. Heat transfer by heat conduction would also be conceivable if a heat-conducting connection is produced between the shut-off unit and the surroundings heat exchanger.

The heat exchanger assembly may also have a radiator grille arranged in front of the surroundings heat exchanger with respect to the air flow, wherein at least one heating module is arranged on the radiator grille. The radiator grille may delimit the vehicle body at the front end. An emblem that identifies the vehicle manufacturer may for example also be arranged on the radiator grille. The radiator grille may be arranged in front of the surroundings heat exchanger, and preferably in front of the aforementioned shut-off unit, with respect to the vehicle longitudinal axis. In this embodiment, it is possible in particular for heat transfer to be provided via the air flow and/or by use of infrared radiation. Each heating module may be arranged on a face of the radiator grille which faces toward the surroundings heat exchanger.

The heat exchanger assembly may also have a fan unit configured to at least partially generate the air flow, wherein at least one heating module is arranged on the fan unit. In particular, the fan unit may have a static part and a part that is rotatable relative to the static part. The rotatable part may also be referred to as a fan propeller, while the static part can be referred to as a fan frame. The fan unit can fully or partially generate the air flow if a traveling movement of the vehicle is not sufficient for this purpose. Depending on the embodiment, the fan unit may be arranged in front of or behind the surroundings heat exchanger with respect to the air flow and/or with respect to the vehicle longitudinal axis. In the case of an arrangement in front of the surroundings heat exchanger, the heat transfer may advantageously take place via the air flow. Irrespective of the arrangement, however, heat transfer by heat conduction is also possible, as is heat transfer by heat radiation. The heating module may in particular be fastened to the fan frame, but an arrangement on the fan propeller would also be conceivable, if an electrical connection is produced for example by use of sliding contacts.

In one embodiment, at least one heating module has an electrically heatable heating element, which has a heating resistor. The heating element is configured to convert electrical energy into heat. Operation with DC voltage and operation with AC voltage are equally conceivable. The heating element may serve to heat the air flow, generate infrared radiation, and/or transfer heat by heat conduction to the surroundings heat exchanger. The heat generation is preferably based on the electrical resistance of the heating element. The specific resistance may be selected in accordance with the size and extent of the heating element, the voltage that is applied in the operating state, and the desired temperature. Combinations of different materials having different specific resistances may self-evidently also be used. To increase the overall resistance while using a low specific resistance, the heating element may be of linear and elongate form, for example in the form of a heating wire. Such a design is also suitable for arranging the heating element over a relatively large area or over a relatively large region. This may be advantageous irrespective of the nature of the heat transfer (heat conduction, air flow or infrared radiation) in order to achieve the most uniform possible heating of the surroundings heat exchanger. Linear structures such as heating wires can also be easily attached to any elements, for example also to the apertured structure of a radiator grille.

Provision may also be made for at least one heating module to have a heat-conducting element which is heat-conductingly connected to a heating element and is configured to dissipate heat from the heating element. The heat-conducting element may optionally also be heat-conductingly connected to the surroundings heat exchanger, though this is not imperatively necessary. Although the heat-conducting element may include a metal such as copper, it is generally not provided for conducting electricity, and may therefore be electrically isolated from the heating element. The heat-conducting element can firstly counteract overheating of the heating element. Secondly, it distributes the heat generated in the heating element over a large area, which in turn can benefit the transfer of heat to the surroundings heat exchanger. The heat-conducting element may also be of elongate and/or linear form, for example in wire form. To achieve the desired action, it is preferable for at least one heat-conducting element to exhibit greater heat conductivity than a base portion on which the heating module is arranged. The base portion may be formed in particular by the surroundings heat exchanger, by the shut-off unit, by the radiator grille or by the fan unit.

The heat exchanger assembly preferably has a control unit configured to activate at least one heating module in a deicing mode and to deactivate same in a normal mode. The control unit is at least indirectly connected to the heating module and configured to manipulate a feed of current or voltage to the heating module. In a deicing mode, the control unit activates the associated heating module, wherein different operating modes or operating intensities may be provided within the deicing mode. The deicing mode is provided in a situation in which icing of the surroundings heat exchanger is at least possible, or in particular has occurred. The normal mode may be provided in a situation in which icing is not possible, recognized however also be provided intermittently between phases of the deicing mode despite the possibility of icing.

The heat exchanger assembly particularly advantageously has at least one sensor for determining a temperature of the surroundings heat exchanger. The sensor may be in direct contact with the surroundings heat exchanger. It may for example be designed as an NTC thermistor, thermocouple, or semiconductor temperature sensor. The sensor could however also operate contactlessly by detecting infrared radiation emitted from the surroundings heat exchanger. It is self-evidently possible for a plurality of sensors to be provided, for example for the purposes of redundancy or in order to detect the temperature of different regions of the surroundings heat exchanger separately. The control unit is preferably configured to switch between the deicing mode and the normal mode depending on the temperature. The control unit may switch into the deicing mode if the temperature falls below a first threshold temperature. The temperature may additionally be compared with an ambient temperature, and a switch into the deicing mode may be made only if the temperature is also lower than the ambient temperature. The control unit may switch into the normal mode if the temperature is higher than a second threshold temperature. The second threshold temperature may be numerically identical to, though may in particular also be higher than, the first threshold temperature. Here, too, the switch may again be dependent on the ambient temperature, for example such that the switch into the normal mode is made only if the temperature is higher, by a defined difference, than the ambient temperature. Aside from the deicing mode being implemented in accordance with the temperature of the surroundings heat exchanger, it is also conceivable for the deicing mode to be implemented in the presence of certain environmental conditions, for example an ambient temperature below 0° C and precipitation in the form of rain or snow.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A heat exchanger assembly for a vehicle, the heat exchanger assembly comprising:
a surroundings heat exchanger that is configured to receive a working fluid and to exchange heat with an air flow; and
at least one heating module which is electrically operable and is configured to, independently of the working fluid, transfer heat to and thus heat the surroundings heat exchanger.

2. The heat exchanger assembly according to claim 1, wherein the at least one heating module is heat-conductingly connected to the surroundings heat exchanger and is configured to transfer heat to the surroundings heat exchanger by heat conduction.

3. The heat exchanger assembly according to claim 1, wherein the at least one heating module is configured to heat the air flow and thereby transfer heat to the surroundings heat exchanger.

4. The heat exchanger assembly according to claim 1, wherein the at least one heating module is configured to transfer heat to the surroundings heat exchanger by infrared radiation.

5. The heat exchanger assembly according to claim 1, wherein the at least one heating module is arranged on the surroundings heat exchanger.

6. The heat exchanger assembly according to claim 1, further comprising an adjustable shut-off unit for manipulating the air flow, wherein the at least one heating module is arranged on the shut-off unit.

7. The heat exchanger assembly according to claim 1, further comprising a radiator grille arranged in front of the surroundings heat exchanger with respect to the air flow, wherein the at least one heating module is arranged on the radiator grille.

8. The heat exchanger assembly according to claim 1, further comprising a fan unit configured to at least partially generate the air flow, wherein the at least one heating module is arranged on the fan unit.

9. Heat exchanger assembly according to claim 1, wherein the at least one heating module has an electrically heatable heating element having a heating resistor.

10. The heat exchanger assembly according to claim 1, wherein the at least one heating module has a heat-conducting element which is heat-conductingly connected to a heating element and is configured to dissipate heat from the heating element.

11. The heat exchanger assembly according to claim 1, further comprising a control unit configured to activate the at least one heating module in a deicing mode and to deactivate the at least one heating module in a normal mode.

12. The heat exchanger assembly according to claim 1, further comprising at least one sensor for determining a temperature of the surroundings heat exchanger, wherein the control unit is configured to switch between the deicing mode and the normal mode depending on the temperature.

13. A heat exchanger assembly for a vehicle, the heat exchanger assembly comprising:
a surroundings heat exchanger that is configured to receive a working fluid and to exchange heat with an air flow;
at least one heating module which is electrically operable and is configured to, independently of the working fluid, transfer heat to and thus heat the surroundings heat exchanger;
a control unit configured to activate the at least one heating module in a deicing mode and to deactivate the at least one heating module in a normal mode; and
at least one sensor for determining a temperature of the surroundings heat exchanger, wherein the control unit is configured to switch between the deicing mode and the normal mode depending on the temperature.

14. The heat exchanger assembly according to claim 13, wherein the at least one heating module is heat-conductingly connected to the surroundings heat exchanger and is configured to transfer heat to the surroundings heat exchanger by heat conduction.

15. The heat exchanger assembly according to claim 13, wherein the at least one heating module is configured to heat the air flow and thereby transfer heat to the surroundings heat exchanger.

16. The heat exchanger assembly according to claim 13, wherein the at least one heating module is arranged on the surroundings heat exchanger.

17. The heat exchanger assembly according to claim 13, further comprising an adjustable shut-off unit for manipulating the air flow, wherein the at least one heating module is arranged on the shut-off unit.

18. The heat exchanger assembly according to claim 13, further comprising a radiator grille arranged in front of the surroundings heat exchanger with respect to the air flow, wherein the at least one heating module is arranged on the radiator grille.

19. The heat exchanger assembly according to claim 13, further comprising a fan unit configured to at least partially generate the air flow, wherein the at least one heating module is arranged on the fan unit.

20. A vehicle comprising:
a heat exchanger assembly for a vehicle, the heat exchanger assembly comprising:
a surroundings heat exchanger that is configured to receive a working fluid and to exchange heat with an air flow; and
at least one heating module which is electrically operable and is configured to, independently of the working fluid, transfer heat to and thus heat the surroundings heat exchanger.
